(19) United States
(12) Patent Application Publication
(10) Pub. No.: US 2019/0210046 A1
(43) Pub. Date: Jul. 11, 2019

(54) SPRINKLER WITH OSCILLATING ROTATION

(71) Applicant: UNIRAIN, S.A., Dos Hermanas (Sevilla) (ES)

(72) Inventor: Enrique GIL BERMUDEZ, Dos Hermanas (Sevilla) (ES)

(21) Appl. No.: 16/303,307

(22) PCT Filed: May 23, 2017
(86) PCT No.: PCT/ES2017/070345

§ 371 Date: Nov. 20, 2018

(30) Foreign Application Priority Data
May 24, 2016 (ES) U201630662

(51) Int. Cl. B05B 3/04

(52) U.S. Cl. CPC B05B 3/0486

(57) ABSTRACT

Oscillating rotation sprinkler that allows the start of the sprinkler even when it is mounted on drainpipes with the nozzle facing the terrain. It comprises a nozzle (4) which controls the passage of water and allows for the outlet of the water running through the drainpipes, an inner body (5) on which the nozzle (4) is mounted, a plate holder (1) arranged around the inner body (5) and a deflector plate (2) which is joined to one end of the plate holder (1) by means of support columns (13) and comprising a plurality of channels (7) that receive and direct the water coming out of the nozzle (4). It also comprises a warped ring (8) arranged between the inner body (5) and the plate holder (1).

### OBJECT OF THE INVENTION

The present invention falls within the technical field of oscillating rotation sprinklers.

More specifically, it describes a sprinkler comprising a warped ring that allows the oscillating rotation sprinkler to start even when it is mounted on drainpipes with the nozzle facing the terrain.

### BACKGROUND OF THE INVENTION

Oscillating rotation sprinklers of a basic design, meaning that they lack swing joints or complex mechanisms, which are generally designed to be mounted on center pivot irrigation systems for spraying through tubes, do not function when mounted on drainpipes. The technical problem associated with oscillating rotation sprinklers of a basic design when they are mounted on drainpipes is that they cannot begin to rotate since they do not have an element to decenter the equilibrium position which impedes the rotation of said plate.

In these cases, in order for the deflector plate in oscillating rotation sprinklers to begin to rotate, it is necessary that in the initial position of the same, meaning the resting position, is decentered with respect to the water tube coming out of the nozzle. However, when the sprinklers are mounted on drainpipes, due to the effect of gravity, the deflector plate tends to place in a centered position with respect to the nozzle. The consequence is that when the system is started and the water comes out of the nozzle, the sprinkler does not rotate.

In the state of the art it is known, for example, a solution based on a complex swing joint system. Said solution comprises the use of a deflector plate, the base of which comprises a part that is semi-spherical, conical or of another similar geometry, and the use of an additional piece containing a protrusion with a geometry that enables the rotation of the base of the defector plate above the same.

Likewise, swivel deflector plate systems comprising the use of springs to enable said swiveling are known. A system of a structure with several legs that surround the sprinkler to support a small decentering pivot under the deflector plate is also known.

The disadvantage of these solutions is that they involve the use of several additional pieces in the oscillating rotation sprinkler, thereby making the manufacturing and assembly of the sprinkler more complex. Moreover, in the case of the solution comprising several additional legs, said legs constitute a barrier for the water and create a plurality of areas on the ground (as many as legs) where the water does not reach.

### DESCRIPTION OF THE INVENTION

The present invention describes an oscillating rotation sprinkler comprising a warped ring that allows the sprinkler to start when it is mounted on drainpipes with the nozzle facing the terrain.

The oscillating rotation sprinkler described is of the type that comprises at least:
a nozzle which controls the passage of water and though which the water which circulates through the drainpipes leaves towards the outside,
an inner body on which the nozzle is mounted,
a plate holder arranged around the inner body,
a deflector plate which is joined to one end of the plate holder by means of support columns and which comprises a plurality of channels that receive and direct the water coming out of the nozzle.

The sprinkler may also comprise a stop, which is mounted on the inner body by means of three slots. The nozzle is supported on said stop, and both elements (stop and nozzle) are maintained in their positions by the tightening of a threaded joint between the inner body and a base connector configured to allow for the connection of the nozzle to the tubes of the drainpipes through which the water arrives to the sprinkler. The stop limits the movement between the plate holder and the inner body.

The key of the invention is that it further comprises a warped ring that is arranged between the plate holder and the inner body. Said warped ring is configured to decenter the deflector plate with respect to the water stream that leaves the sprinkler nozzle thus enabling the sprinkler to start its movement even when it is mounted on drainpipes with the nozzle facing the terrain.

It is a ring with a warped configuration that ensures that the deflector plate comes out of its resting position when receiving the water stream projected by the nozzle. This causes that when the water comes out of the nozzle, it is directly distributed through the different channels of the deflector plate to prevent it from directly hitting the center of said plate. This way the deflector plate begins to rotate due to the action of the water, which enters the channels while it is oscillating, thanks to the imbalance produced by this ring, maintaining said oscillating rotation motion.

In other words, the warped ring provides a very sensitive imbalance that allows the deflector plate joined to the plate holder to begin rotating when water begins to come out of the nozzle, causing oscillatory motion.

The present invention therefore proposes a system for decentering the deflector plate with respect to the nozzle which is entirely different from systems known in the state of the art and which allows for considerable cost saving. With a single piece, in this case the warped ring, the technical problem of starting the oscillating rotation sprinkler when it is mounted on drainpipes is solved.

As previously described, the technical problem solved by the proposed sprinkler compared to those already known in the state of the art is that it avoids, when starting the sprinkle, said sprinkle from standing still (without oscillation) when the plate is already receiving the water stream coming out of the nozzle.

With respect to a simple oscillating rotation sprinkler known in the state of the art, the present invention differs in that it comprises a warped ring. It is a single piece that has a low manufacturing and assembly cost.

Likewise, the sprinkler described has a much more compact design than sprinklers in the state of the art which allow for the start thereof when they are mounted on drainpipes. This allows the amount of material necessary for the manufacturing thereof to be reduced. Solutions in the state of the art describe more complex mechanisms that imply a greater number of pieces to manufacture and assemble.

### DESCRIPTION OF THE DRAWINGS

In order to complement the description being made and with the object of helping to better understand the characteristics of the invention, in accordance with a preferred practical embodiment thereof, said description is accompanied, as an integral part thereof, by a set of drawings where, in an illustrative and non-limiting manner, the following has been represented:

FIG. 1 shows a profile view of the oscillating rotation sprinkler.

FIG. 2 shows a cross-sectional view of the oscillating rotation sprinkler.

FIG. 3 shows an exploded view of the oscillating rotation sprinkler.

### PREFERRED EMBODIMENT OF THE INVENTION

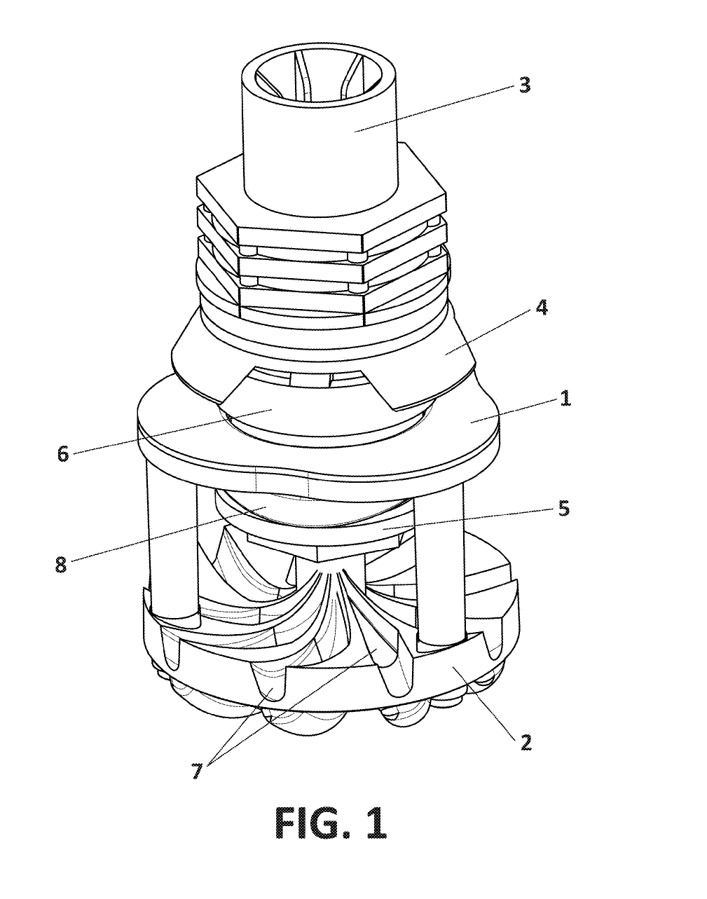

What follows is a description, with the help of FIGS. 1 to 3, of an exemplary embodiment of the invention.

FIG. 1 shows the oscillating rotation sprinkler in a perspective view. As can be seen in the figure, the sprinkler of the invention is configured to be mounted on drainpipes, such that the sprinkler nozzle is facing the terrain.

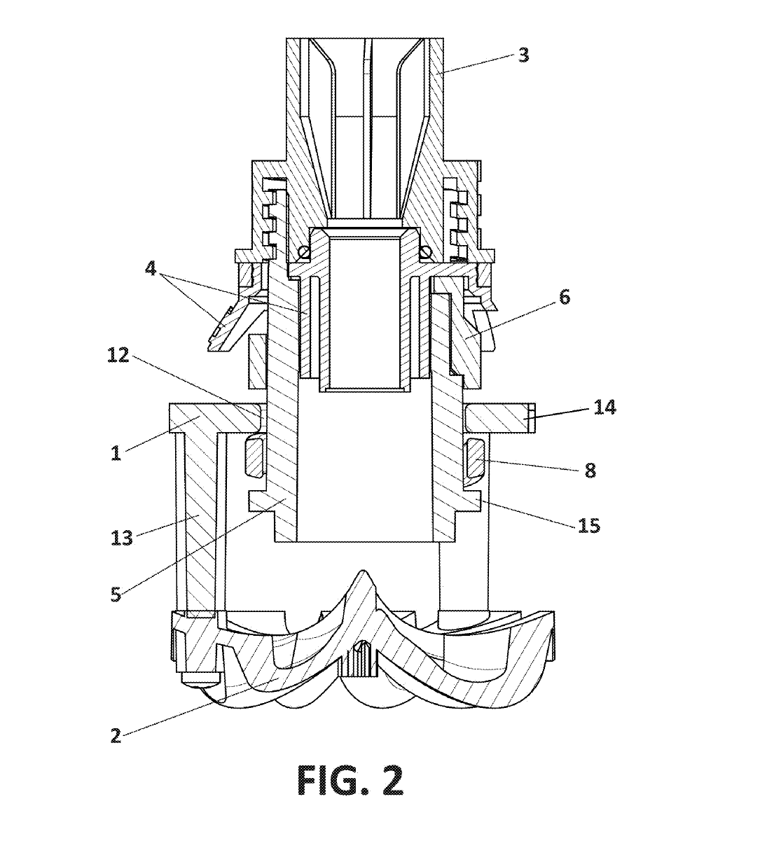

FIG. 2 shows the oscillating rotation sprinkler in a cross-sectional view that allows the relationship and position between the different elements of the oscillating rotation sprinkler to be viewed.

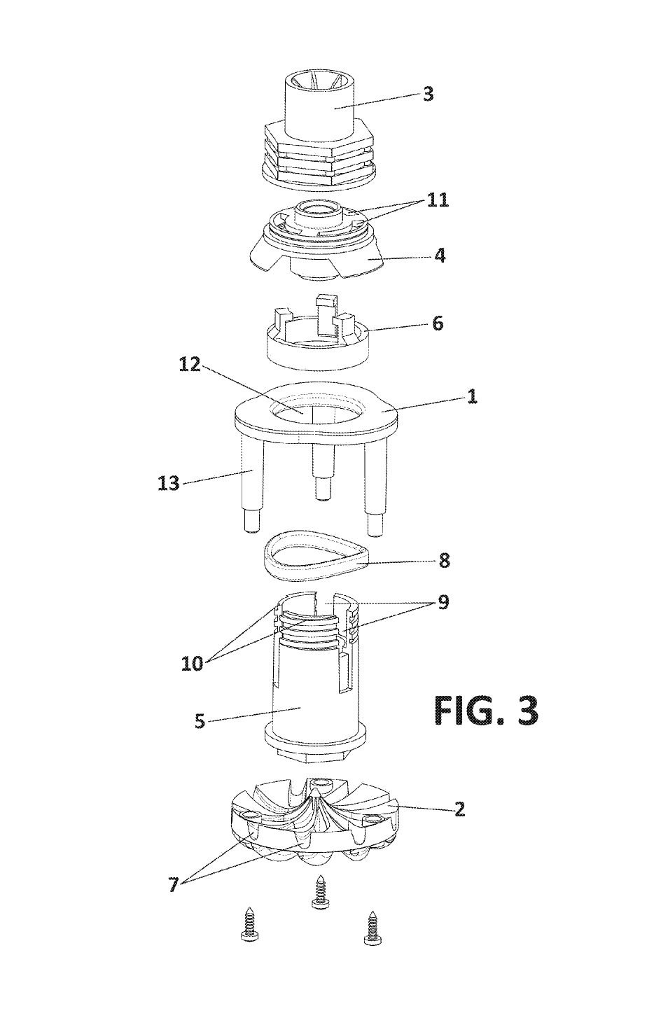

Likewise, FIG. 3 shows the different elements that make up the sprinkler in an exploded view. More specifically, the sprinkler must comprise at least:
a nozzle (4) which controls the passage of water and allows the water that circulates through the drainpipes to leave towards the outside;
an inner body (5) on which the nozzle (4) is mounted;
a plate holder (1) arranged around the inner body (5); and
a deflector plate (2) which is joined to one end of the plate holder (1) and which comprises a plurality of channels (7) that receive and direct the water coming out of the nozzle (4).

As can be seen in FIG. 2, the inner body (5) is preferably of a hollow cylindrical configuration. The water coming out of the nozzle (4) passes through said inner body (5) to the deflector plate (2). In the exemplary embodiment shown in FIG. 3, the upper end of the inner body (5) comprises slots (9), which divide the upper end into upper sections (10) configured to be introduced in a plurality of through holes (11) present on the nozzle (4). This way the nozzle (4) and the inner body (5) are linked.

The sprinkler may also comprise a base connector (3) configured to allow for the connection of the nozzle (4) to the drainpipes through which the water reaches the sprinkler. Preferably, said base connector (3) is joined to the inner body (5), as observed in FIG. 2, by means of a thread in correspondence with the upper end of the inner body (5).

The plate holder (1) has an upper section (14) in which there is at least one opening (12), shown in FIG. 3, through which the inner body (5) is arranged, and has a plurality of support columns (13), also shown in FIG. 3, which come out of said upper section (14) and which are configured to be joined by the upper end thereof to the deflector plate (2).

The key of the oscillating rotation sprinkler described is that it comprises a warped ring (8) which is arranged between the inner body (5) and the plate holder (1) and which has a warped configuration. Said warped ring (8) can also be seen in FIG. 3.

More specifically, as shown in FIG. 2, the inner body (5) comprises an outer perimeter projection (15) arranged on the lower end thereof. The warped ring (8) is arranged, as shown in FIG. 2, around the inner body (5) in the space confined between the upper section (14) of the plate holder (1) and the outer perimeter projection (15) of the inner body (5).

As seen in the example in FIG. 1, the warped ring (8) causes the deflector plate (2) to have an unstable equilibrium. This way, when the water starts coming out of the nozzle (4) and collides with the deflector plate (2), the deflector plate (2) begins to oscillate. This oscillating movement is maintained the entire time the sprinkler is functioning.

Another element the sprinkler may comprise is a stop (6) as shown in the figures, such as in FIG. 3, which prevents the plate holder (1) and the warped ring (8) from coming out of their assembled position. The stop (6) has a diameter, which is similar to that of the perimeter projection (15) of the inner body (5) and limits the degree of oscillation of the plate holder (1).

The plate holder (1) and the warped ring (8) are not joined. Both are trapped between the perimeter projection of the inner body (5) and the stop (6). If the latter is disassembled, it is necessary to disassemble the deflector plate (2) of the plate holder (1) to be able to remove it and be able to then remove the warped ring (8).

Preferably, the stop (6) is mounted on the inner body (5) by means of three slots and on which the nozzle (4) is supported. Both pieces are fixed by the threaded joint between the base connector (3) and the inner body (5) as shown in FIG. 2.

1. An oscillating rotation sprinkler configured to be mounted on drainpipes and comprising at least:
a nozzle (4) which controls the passage of water and allows the water that circulates through the drainpipes to leave towards the outside;
an inner body (5) on which the nozzle (4) is mounted;
a plate holder (1) arranged around the inner body (5); and
a deflector plate (2) which is joined to one end of the plate holder (1) by means of support columns (13) and comprising a plurality of channels (7) that receive and direct the water coming out of the nozzle (4);
characterized in that it comprises:
a warped ring (8) arranged between the inner body (5) and the plate holder (1) and having a warped configuration.

2. The oscillating rotation sprinkler according to claim 1, characterized in that:
the inner body (5) comprises an outer perimeter projection (15) on the lower end thereof;
the plate holder (1) comprises an upper section (14) with at least one opening (12) through which the inner body is arranged (5); and
the warped ring (8) is arranged around the inner body (5) in the space confined between the upper section (14) of the plate holder (1) and the outer perimeter projection (15).

3. The oscillating rotation sprinkler according to claim 1, characterized in that it further comprises a base connector (3) joined to the inner body (5) and configured to allow for connection to the drainpipe.

4. The oscillating rotation sprinkler according to claim 3, characterized in that the joint between the base connector (3) and the inner body (5) is a threaded joint.

5. The oscillating rotation sprinkler according to claim 1, characterized in that it further comprises a stop (6) mounted on the inner body (5), the nozzle (4) being arranged on said stop (6).

6. The oscillating rotation sprinkler according to claims 3 and 5, characterized in that the base connector (3) maintains the stop (6) and the nozzle (4) in their positions.
